(19) United States
(12) Patent Application Publication
(10) Pub. No.: US 2026/0287019 A1
(43) Pub. Date: Sep. 24, 2026

(54) BEARING SYSTEM INCLUDING A GROUNDING BRUSH ASSEMBLY AND ASSOCIATED ASSEMBLY

(71) Applicants: AKTIEBOLAGET SKF, GOTEBORG (SE); SKF Aerospace France S.A.S, Perrigny (FR)

(72) Inventors: Benoit ARNAULT, Saint-Cyr-sur-Loire (FR); Franck GERVAIS, Bourg de Péage (FR)

(21) Appl. No.: 19/564,504

(22) Filed: Mar. 12, 2026

(30) Foreign Application Priority Data
Mar. 21, 2025 (FR) 2502891FR

(51) Int. Cl. F16C 41/00; H02K 11/40

(52) U.S. Cl. CPC F16C 41/002; H02K 11/40; F16C 2380/26

(57) ABSTRACT

A bearing system including a bearing having an inner ring and an outer ring, and a grounding brush assembly including a brush axially offset outwardly relative to the inner ring of the bearing and provided with a plurality of conductive fibers and a support in which the conductive fibers are mounted. The grounding brush assembly further includes a brush mounting plate secured to the support of the brush and including a mounting portion arranged inside a groove formed in a bore of the outer ring of the bearing.

### CROSS-REFERENCE

This application claims priority to French patent application no. 2502891 filed on Mar. 21, 2025, the contents of which are fully incorporated herein by reference.

### BACKGROUND OF THE INVENTION

The present invention relates to the field of grounding devices for controlling the shaft current generated in electric motors or electrical machines, and more particularly to grounding brush assemblies.

In an electric motor or electrical machine, at least one rolling bearing is mounted between the motor housing or the housing of the electrical machine and the rotary shaft, in order to support the shaft.

During operation, when the shaft is rotating, an electrical potential difference may appear between the shaft and the motor housing or the housing of the electrical machine, thereby generating an electric current between the inner ring of the rolling bearing, which is fixed to the shaft, and the outer ring, which is fixed to the housing.

The electric current flowing through the components of the rolling bearing may damage these components, in particular the rolling elements and the raceways formed in the inner and outer rings. Electrical discharges may also generate vibrations.

To overcome these drawbacks, it is known in the art to earth or ground the rotary shaft using a grounding brush or grounding brush comprising conductive fibers. The grounding brush is generally mounted in the bore of the electric motor housing in such a manner that the free ends of the fibers are in radial contact with the outer surface of the rotary shaft.

By virtue of the conductivity of the fibers, the brush is kept at the same electrical potential as the electric motor housing. The inner and outer rings of the rolling bearing are also brought to the same electrical potential, thereby reducing, or even eliminating, problematic electrical discharges through the rolling bearing.

US Patent Publication No. 2021/0021180 discloses a grounding brush assembly comprising a grounding brush provided with a plurality of conductive fibers, a support inside of which the conductive fibers are mounted and an annular mounting plate comprising a plurality of tabs for radial and axial retention of the support and an outer annular flange radially surrounding the brush and the tabs.

It is also possible to equip the outer surface of the outer ring of the rolling bearing with the grounding brush assembly.

However, with a solution of this kind, mounting this assembly between the housing and the rotary shaft of the electric motor may be difficult to carry out.

The present invention aims to overcome this drawback.

### SUMMARY OF THE INVENTION

The invention relates to a bearing system comprising a bearing provided with a first ring and a second ring configured to rotate relative to one another.

The system further comprises a grounding brush assembly comprising a brush axially offset outwardly relative to the inner ring of the bearing and provided with a plurality of conductive fibers and a support in which the conductive fibers are mounted. The conductive fibers preferably project radially inwardly relative to the support.

The grounding brush assembly further comprises a brush mounting plate secured to the brush support. The mounting plate comprises a mounting portion arranged inside a groove formed in a bore of the outer ring of the bearing. The groove is provided with first and second lateral walls axially facing one another, a bottom connecting the first and second lateral walls and an inner edge extending between the second lateral wall and an end face of the outer ring.

According to a general feature, the mounting portion of the mounting plate comprises at least one collar bearing axially against the first lateral wall of the groove. The free end of the collar is radially offset inwardly relative to the inner edge of the groove or is flush with the inner edge.

According to another general feature, the mounting portion of the mounting plate comprises at least one protrusion projecting from the collar outwardly towards the bottom of the groove. The free end of the protrusion is radially offset outwardly relative to the inner edge of the groove, in order to ensure axial retention of the mounting plate relative to the outer ring.

According to yet another general feature, the collar of the mounting portion of the mounting plate locally has at least one region of reduced axial thickness relative to the axial thickness of the remainder of the collar, which remainder is located in the radial extension of the protrusion.

This design makes it possible to facilitate mounting of the system inside the housing of the associated electric motor, to the extent that the mounting portion of the mounting plate is fixed in the groove of the bore of the outer ring of the bearing.

The protrusion of the mounting portion of the mounting plate ensures fixation of the assembly relative to the outer ring of the bearing in a simple and economical manner. Advantageously, the protrusion is formed by local deformation of material of the collar, for example by peening.

The mounting portion of the mounting plate may be provided with at least one blind notch formed in the collar, oriented axially outwardly and delimiting the region of reduced axial thickness.

Preferably, the protrusion of the mounting portion of the mounting plate bears radially against the bottom of the groove of the outer ring of the bearing. Alternatively, the protrusion may remain radially spaced apart from the bottom of the groove.

In one embodiment, the mounting portion of the mounting plate comprises a plurality of protrusions each projecting from the collar outwardly towards the bottom of the groove and spaced apart from one another in the circumferential direction, the free end of each protrusion being radially offset outwardly relative to the inner edge of the groove, the collar locally having a plurality of regions of reduced axial thickness relative to the axial thickness of the remainder of the collar, each of the regions being located in the radial extension of one of the protrusions. The protrusions may be regularly spaced apart from one another in the circumferential direction.

In one embodiment, the collar of the mounting portion of the mounting plate remains spaced apart from the second lateral wall of the groove of the outer ring of the bearing.

According to a particular design, the collar of the mounting portion of the mounting plate is annular. Alternatively, the collar may extend over an angular sector of less than 360°. In another embodiment, the mounting portion of the mounting plate may comprise a plurality of collars bearing axially against the first lateral wall of the groove of the outer ring and spaced apart from one another in the circumferential direction. In this case, each collar, only some of the collars or a single collar may be provided with at least one protrusion.

Preferably, the mounting plate is made in one piece.

The invention also relates to an electric motor comprising a housing, a shaft and at least one bearing system such as that defined above, mounted radially between the housing and the shaft.

The invention further relates to a method for assembling a bearing system as defined above, comprising the following steps:
axially displacing the grounding brush assembly relative to the bearing, in order to bring the collar of the mounting portion of the mounting plate into axial bearing against the first lateral wall of the groove of the outer ring of the bearing, and then
locally deforming material of the collar to form the protrusion by radial flow of material.

### BRIEF DESCRIPTION OF THE SEVERAL VIEWS OF THE DRAWINGS

The present invention will be better understood on studying the detailed description of one embodiment, given purely by way of non-limiting example and illustrated by the accompanying drawings, in which:

FIG. 1 is a perspective view of a bearing system according to an exemplary embodiment of the invention,

FIG. 2 is a front view of the bearing system in FIG. 1;

FIG. 3 is a half cross-sectional view taken along axis III-III in FIG. 2;

FIG. 4 is a half cross-sectional view taken along axis IV-IV in FIG. 2;

FIG. 5 is a cross-sectional view taken along axis V-V in FIG. 4;

FIG. 6 is a detailed view of FIG. 5;

FIG. 7 is a detailed view of FIG. 4;

FIG. 8 is a detailed view of FIG. 2;

FIG. 9 is a front perspective view of a grounding brush assembly of the bearing system in FIG. 1 before assembly with the bearing of the system;

FIG. 10 is a rear perspective view of a grounding brush assembly of the bearing system in FIG. 1 before assembly with the bearing of the system; and

FIG. 11 is a half cross-sectional view schematically illustrating the mounting of the bearing system in FIG. 1 inside a housing of an electrical machine.

### DETAILED DESCRIPTION OF THE INVENTION

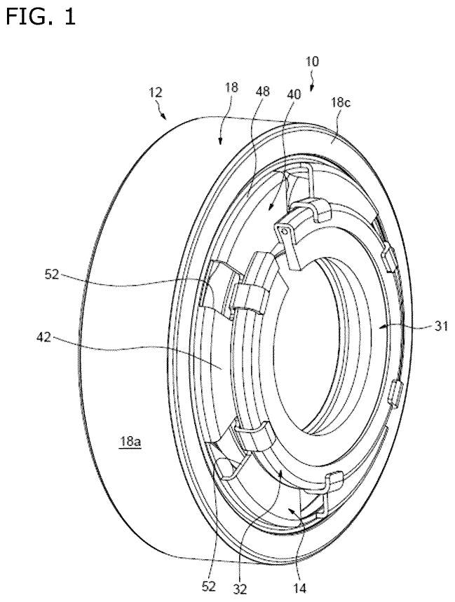

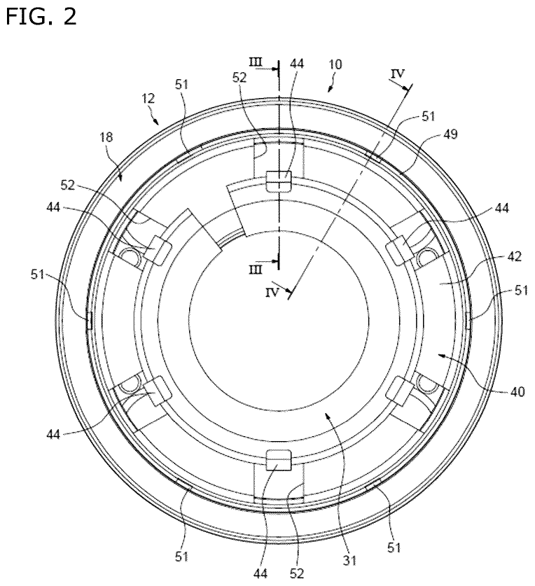

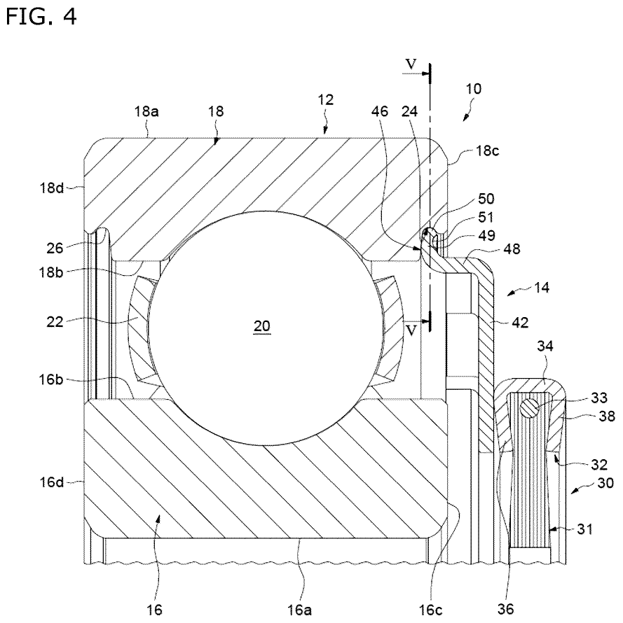

The bearing system illustrated in FIGS. 1 to 4 and designated by reference sign 10 as a whole is intended to be mounted radially between a housing and a rotary shaft of an electric motor or electrical machine.

The bearing system 10 comprises a bearing 12 and a grounding brush assembly 14 mounted on the bearing 12.

The bearing 12 is provided with an inner ring 16 and a second outer ring 18 which are configured to rotate relative to one another about the axis (not shown) of the bearing 12. The inner ring 16 and the outer ring 18 of the bearing 12 are concentric and extend axially along the axis of the bearing 12. The inner ring 16 and outer ring 18 are made of steel. The rings 16, 18 are of the solid type.

In the illustrated exemplary embodiment, the bearing 12 further comprises a row of rolling elements 20, preferably balls but may be cylindrical rollers, tapered rollers needles or any other type of rolling element. The rolling elements 20 are radially interposed between the inner ring 16 and the outer ring 18. The bearing 12 also comprises a cage 22 for maintaining regular circumferential spacing of the rolling elements 20.

The inner ring 16 includes a cylindrical bore 16a, a cylindrical axial outer surface 16b radially opposite the bore 16a, and first and second opposed radial end faces 16c, 16d axially delimiting the bore 16a and the outer surface 16b. The bore 16a and the outer surface 16b define the radial thickness of the inner ring 16. The end faces 16c, 16d define the axial length of the inner ring 16.

The outer ring 18 includes a cylindrical axial outer surface 18a, a cylindrical bore 18b radially opposite the outer surface 18a, and first and second opposed radial end faces 18c, 18d axially delimiting the bore 18b and the outer surface 18a. The outer surface 18a and the bore 18b define the radial thickness of the outer ring 18. The end faces 18c, 18d define the axial length of the outer ring 18.

The outer ring 18 further comprises first and second annular grooves 24, 26 formed in the bore 18b and extending radially outwardly. Each groove 24, 26 is oriented radially towards the inner ring 16.

The grooves 24, 26 are arranged axially on either side of the row of rolling elements 20. The groove 24 is located axially near the end face 18c of the outer ring 18 and the groove 26 is located axially near the end face 18d. The grooves 24, 26 are symmetrical with respect to the median radial plane of the bearing system. Alternatively, the outer ring 18 may include only the groove 24.

As will be described in greater detail below, the grounding brush assembly 14 is fixed within the groove 24 of the outer ring 18 of the bearing 12. The assembly 14 has a generally annular shape. The assembly 14 includes a grounding brush 30 and a brush mounting plate 40 configured to radially center the brush 30. The mounting plate 40 is fixed in the groove 24 of the outer ring 18 of the bearing 12.

The brush 30 is axially offset outwardly relative to the inner ring 16 of the bearing 12. In other words, the brush 30 is axially spaced apart from the inner ring 16 of the bearing 12. The brush 30 is arranged outside of the bearing 12.

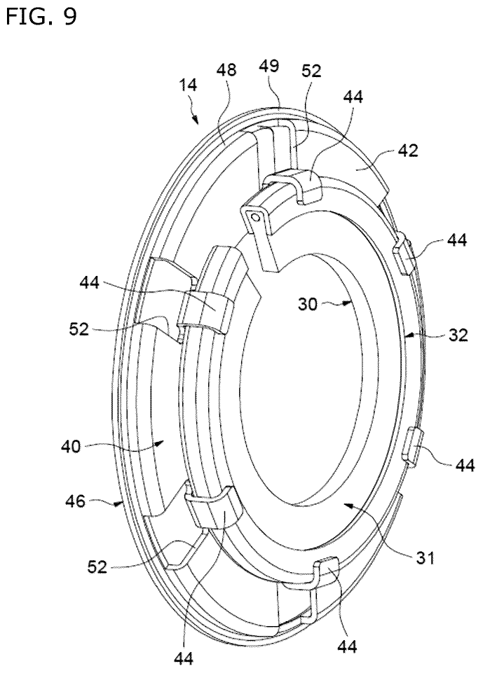

The brush 30 includes a plurality of individual conductive fibers 31 intended to be arranged circumferentially around the rotary shaft of the motor. The conductive fibers 31 may be made of carbon, stainless steel or conductive plastics, such as acrylic fibers or nylon. The conductive fibers 31 are shown schematically in FIGS. 1, 2, 9 and 10.

The brush 30 further comprises a retaining member or support 32 in which the conductive fibers 31 are mounted or disposed. The conductive fibers 31 project radially inwardly relative to the support 32.

In the illustrated exemplary embodiment, the support 32 is in the form of an open ring. The support 32 is made of a rigid material. The support 32 may be produced by cutting and stamping. The support 32 is made of an electrically conductive material, such as aluminum, stainless steel, bronze, copper or another material, for example. Alternatively, the support 32 may be made of an electrically non-conductive material provided with a conductive coating or a conductive paint.

The brush 30 also preferably comprises a ring 33 around which the conductive fibers 31 are arranged inside the support 32. The ring 33 performs a function of supporting or retaining the conductive fibers 31. The ring 33 is mounted or disposed inside the support 32.

The support 32 of the brush 30 comprises an axial mounting portion 34 and two opposed lateral flanks 36, 38 extending inwardly from the mounting portion 34 and axially surrounding the conductive fibers 31. The conductive fibers 31 bear axially on either side against the lateral flanks 36, 38. The conductive fibers 31 bear radially against the mounting portion 34. The conductive fibers 31 project radially inwardly relative to the lateral flanks 36, 38 of the support 32.

The mounting portion 34 and the two lateral flanks 36, 38 define a channel that is open radially on the inner side and within which the conductive fibers 31 are partially located.

The lateral flank 36 extends from one end of the mounting portion 34 and the lateral flank 38 extends from the opposite end thereof. The lateral flanks 36, 38 preferably extend obliquely inwardly from the mounting portion 34. The lateral flanks 36, 38 are symmetrical with respect to a median radial plane of the support 32. Alternatively, only one of the lateral flanks 36, 38 could extend obliquely inwardly. In another variant, both lateral flanks 36, 38 could extend substantially or entirely radially. The mounting portion 34 preferably extends axially, but may alternatively extend obliquely.

The brush 30 is in the form of an open ring. This shape or configuration allows the brush 30 to adapt to different diameters of the motor shaft. In general, the ends of the brush 30 are not fixed to one another. As a variant, the ends of the brush 30 may be fixed to one another.

The conductive fibers 31 have distal free ends that are intended to come into radial contact with the outer surface of the rotary shaft of the motor. The free ends of the conductive fibers 31 define the inner diameter of the conductive fibers 31 and, more generally, the inner diameter of the brush 30.

In the illustrated exemplary embodiment, the free ends of the conductive fibers 31 are radially offset inwardly relative to the bore 16a of the inner ring 16 of the bearing 12. In other words, the free ends of the conductive fibers 31 project radially relative to the bore 16a of the inner ring 16. Alternatively, the free ends of the conductive fibers 31 could be radially flush with the bore 16a. In another alternative, the free ends of the conductive fibers 31 could be radially set back or offset relative to the bore 16a, in the event that the bearing system further comprises a sleeve mounted in the bore 16a of the inner ring 16.

The mounting plate 40 of the grounding brush assembly 14 comprises an annular radial portion 42 and a plurality of tabs 44 for axial and radial retention of the brush 30, extending from the radial portion 42.

The mounting plate 40 also includes a mounting portion 46 arranged in the groove 24 of the outer ring 18 of the bearing 12 and a connecting portion 48 connecting the mounting portion 46 to the radial portion 42.

The radial portion 42 of the mounting plate 40 bears axially against the support 32 of the brush 30. More specifically, the radial portion 42 bears axially against the lateral flank 36 of the support 32. The radial portion 42 is axially offset outwardly relative to the inner ring 16 of the bearing. The radial portion 42 remains axially spaced apart from the end face 16c of the inner ring 16. The support 32 of the brush 30 bears axially against the radial portion 42 on the side axially opposite the inner ring 16. Alternatively, depending on the design of the mounting plate 40, the support 32 of the brush 30 may bear axially against the radial portion 42 on the side axially facing the inner ring 16. In this case, the support 32 is arranged axially between the radial portion 42 of the mounting plate 40 and the face 16c of the inner ring 16, while remaining axially spaced apart from the face 16c.

The tabs 44 of the mounting plate 40 are spaced apart from one another in the circumferential direction, in this case in a regular or even manner. Alternatively, an irregular circumferential spacing or staggering could be provided. In the illustrated exemplary embodiment, the mounting plate 40 has six tabs 44r. Alternatively, a greater or lesser number of tabs 44 may be provided. For example, it is possible to provide two tabs 44 or at least four tabs. Preferably, the number of tabs 44 is at least two.

Each tab 44 projects axially relative to the radial portion 42. Each tab 44 locally surrounds the support 32 of the brush 30 radially and is in radial contact with the mounting portion 34 of the support 32. The support 32 is held axially bearing against the radial portion 42 of the mounting plate 40 by the tabs 44. The tabs 44 make it possible to retain the grounding brush 30 both axially and radially. The lateral flank 36 of the support 32 bears against the radial portion 42 of the mounting plate 40 and the lateral flank 38 bears against the tabs 44. The tabs 44 are identical to one another here.

Each tab 44 is provided with an axial portion extending axially from the radial portion 42, locally surrounding the support 32 radially and being in radial contact therewith, and with a portion folded radially inwardly, which is provided at the free end of the axial portion. The folded portion of each tab 44 makes it possible to axially retain the support 32 of the grounding brush 30. The folded portion of each tab 44 is in axial contact against the lateral flank 38 of the support 32.

The connecting portion 48 of the mounting plate is annular and extends axially. The connecting portion 48 extends axially between the outer, large-diameter edge of the radial portion 42 and the inner, small-diameter edge of the mounting portion 46. The mounting portion 46 is radially offset outwardly relative to the tabs 44 and axially offset inwardly toward the bearing 12 relative to the tabs 44.

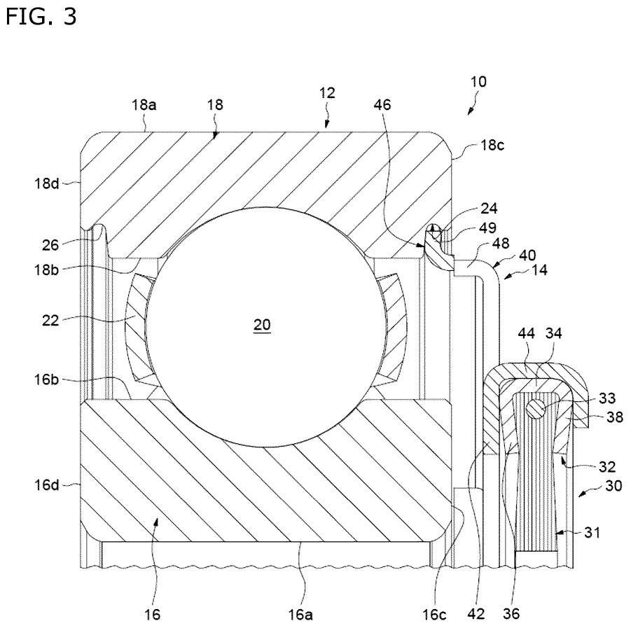

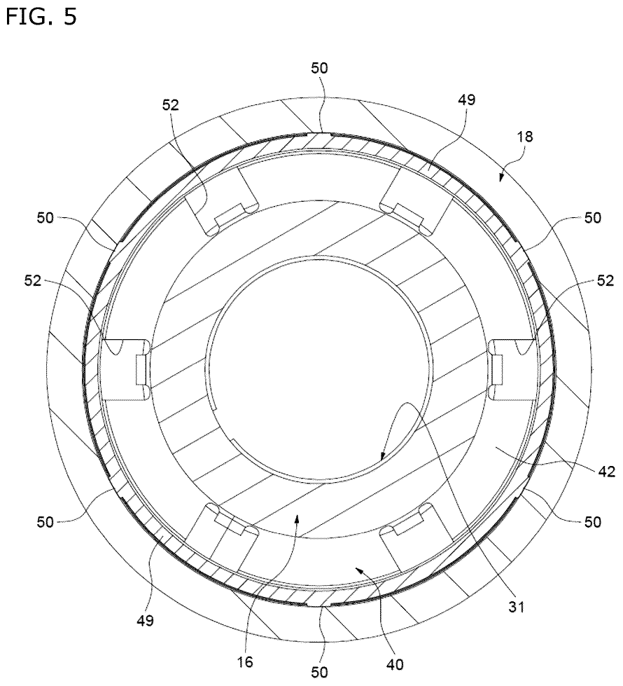

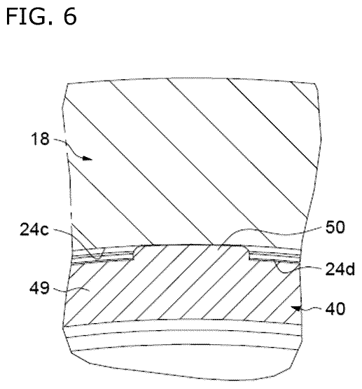

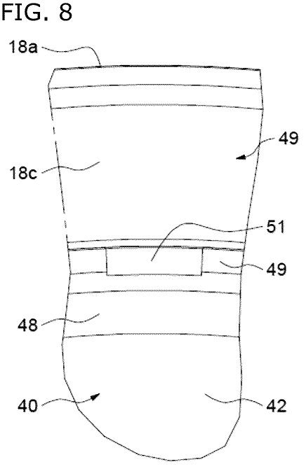

As shown more clearly in FIGS. 3 to 8, the mounting portion 46 of the mounting plate 40 includes an annular collar 49 that projects radially outwardly from the connecting portion 48 of the mounting plate 40. The collar 49 is arranged in the groove 24 of the outer ring 18 of the bearing 12.

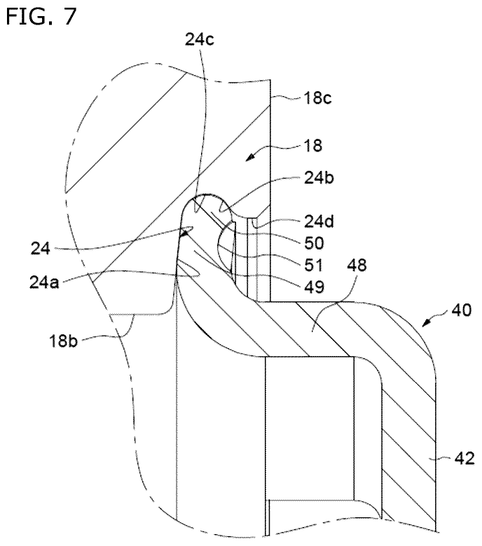

As best shown in FIG. 7, the groove 24 is provided with first and second lateral walls 24a, 24b, respectively, or flanks axially facing one another. The first and second lateral walls 24a, 24b are connected by a bottom 24c oriented radially inwardly. The bottom 24c is concave in this case. Alternatively, the bottom 24c could have other profiles, for example flat. In another variant, the groove 24 could be devoid of a bottom 24c. In this case, the lateral walls 24a, 24b are connected to one another.

The groove 24 is also provided with an inner edge 24d extending from the small-diameter end of the second lateral wall 24b and joining the end face 18c of the outer ring 18. The edge 24d extends between the second lateral wall 24b and the end face 18c and connects the second lateral wall 24b and the end face 18c. The edge 24d is radially offset inwardly relative to the bottom 24c. Preferably, the groove 24 has a stepped shape such that the second lateral wall 24b has a reduced radial dimension relative to the first lateral wall 24a.

The collar 49 projects radially outwardly from the edge of the connecting portion 48 of the mounting plate 40 that is axially opposite the radial portion 42. The collar 49 is flat. The collar 49 bears axially against the first lateral wall 24a of the groove 24 of the outer ring 18 of the bearing 12. There is no axial contact between the collar 49 and the second lateral wall 24b of the groove. In other words, the collar 49 remains spaced apart from the second lateral wall 24b of the groove 24. The collar 49 bears axially against the major part of the first lateral wall 24a of the groove 24. The free end of the collar 49 is radially offset inwardly relative to the inner edge 24d of the groove 24. The outer diameter of the collar 49 is smaller than the inner diameter of the inner edge 24d of the groove. Alternatively, the outer diameter of the collar 49 could be equal to the inner diameter of the inner edge 24d of the groove.

The mounting portion 46 of the mounting plate 40 further comprises a plurality of protrusions 50 projecting from the collar 49 outwardly toward the bottom 24c of the groove 24. Each protrusion 50 projects outwardly from the outer peripheral edge of the collar 49. The outer diameter of the protrusions 50 is greater than the outer diameter of the collar 49. The outer diameters of the protrusions 50 collectively define the outer diameter of the mounting plate 40.

The protrusions 50 are spaced apart from one another in the circumferential direction, preferably in a regular or even manner. Alternatively, an irregular circumferential spacing of the protrusions 50 could be provided. In the illustrated exemplary embodiment, the protrusions 50 are six in number. Alternatively, a greater or lesser number of protrusions 50 may be provided. It is possible to provide a single protrusion 50, or at least two or four protrusions 50. Preferably, the number of protrusions 50 is at least two. The protrusions 50 are preferably formed identical to one another in this case. Alternatively, the protrusions 50 may be of different sizes and, for example, have different circumferential dimensions.

Each protrusion 50 bears axially, on one side, against the first lateral wall 24a of the groove 24 of the outer ring 18 and, on the other side, against the second lateral wall 24b. Each protrusion 50 conforms to the shape of the bottom 24c of the groove. The free end of each protrusion 50 is radially offset outwardly relative to the inner edge 24d of the groove. Each protrusion 50 ensures axial retention of the mounting plate 40 relative to the outer ring 18. Axial retention of the mounting plate 40 relative to the outer ring 18 is ensured by diametral interference between the protrusions 50 and the second lateral wall 24b of the groove 24. The outer diameter of the protrusions 50 is greater than the inner diameter of the inner edge 24d of the groove 24.

The mounting portion 46 of the mounting plate 40 further includes a plurality of notches 51 formed in the collar 49. The notches 51 are blind and oriented axially toward the outside of the bearing 12. The notches 51 do not extend through the axial thickness of the collar 49. Each notch 51 extends axially from the outer face of the collar 49, i.e. the face oriented axially towards the outside of the bearing 12. Each notch 51 extends into the thickness of the collar 49 without opening onto the inner face thereof, which bears against the first lateral wall 24a of the groove of the outer ring. Each notch 51 locally forms a cavity extending from, and recessed relative to, the outer face of the collar 49. Each notch 51 extends over a limited angular sector, for example between 5° and 10°. Each notch 51 has a rectangular shape in this case.

Alternatively, the notches 51 could have any other appropriate shape.

The notches 51 and the protrusions 50 are associated in pairs of one notch 51 and one protrusion 50. Each notch 51 of a pair is radially offset inwardly relative to the protrusion 50 of the pair, being located in the radial extension of the protrusion 50. Like the protrusions 50, the notches 51 are also regularly spaced from one another in the circumferential direction and are identical to one another.

In the region of each notch 51, the collar 49 has a reduced axial thickness locally relative to the axial thickness of the remainder of the collar 49 outside the regions of the notches 51.

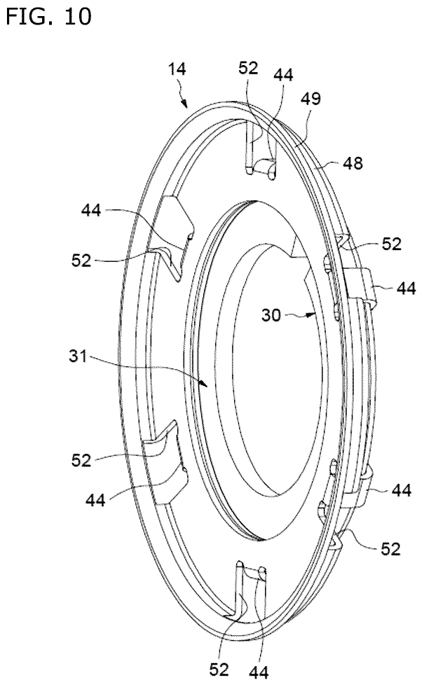

As will be described in greater detail below, the notches 51 are obtained on the collar 49 of the mounting portion 46 of the mounting plate by local deformations of material during the formation of the protrusions 50. A plurality of through-openings 52 is formed through the thickness of the radial portion 42 and of the connecting portion 48 of the mounting plate 40. The openings 52 are formed during partial cutting of the mounting plate 40 to form the tabs 44. The tabs 44 are formed by cutting, bending and crimping of the mounting plate 40. The openings 52 are spaced apart from one another in the circumferential direction. Each tab 44 is circumferentially aligned with the associated opening 52. The number of openings 52 corresponds to the number of tabs 44. As shown in FIG. 10, the root of each tab 44 extends from an inner edge of the associated opening 52, which is located on the radial portion 42. Each notch 51 of the mounting portion 46 of the mounting plate 40 is located circumferentially between two successive openings 52 in this case.

The mounting plate 40 is produced by cutting and stamping. The mounting plate 40 is made of a conductive material, such as aluminum, stainless steel, bronze, copper, or another material, for example. Alternatively, the mounting plate 40 may be made of an electrically non-conductive material provided with a conductive coating or a conductive paint. In this case, the mounting plate 40 is made in one piece.

To assemble the bearing system 10, the following procedure is carried out.

In a first step, after manufacture of the grounding brush assembly 14, the assembly 14 is displaced axially relative to the bearing 12, in order to bring the collar 49 of the mounting plate into axial bearing against the first lateral wall 24a of the groove 24 of the outer ring. During this relative displacement, the free end of the collar 49 remains radially spaced apart from the inner edge 24d of the groove 24 of the outer ring 18. In other words, the free end of the collar 49 does not come into interference with the inner edge 24d of the groove 24.

Next, in a second step, the collar 49 of the mounting plate 40 is locally deformed using a tool, in order to form the protrusions 50 by radial flow of material of the collar 49. To achieve this, an axial force is applied to the collar 49 using the tool so as to obtain, by material upsetting and therefore without chip removal, the formation of the notches 51 that correspond to the imprint of the teeth of the tool and the formation of the protrusions 50 by outward radial flow of material in the direction of the bottom 24c of the groove of the outer ring. The notches 51 and the protrusions 50 are obtained by local plastic deformation of the collar 49 of the mounting plate.

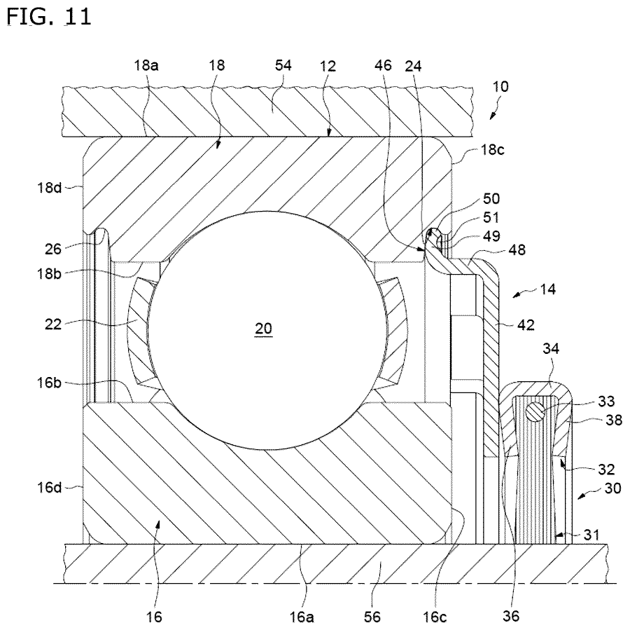

As illustrated in FIG. 11, the bearing system 10 can be mounted inside the bore of the housing 54 of the associated electric motor and on the rotary shaft 56 of the motor. The bearing 12 is mounted radially between the bore of the housing 54 and the rotary shaft 56 of the motor.

During operation of the electric motor, the electrical charges that accumulate on the shaft 56 are dissipated towards the housing 54 through the conductive fibers 31, the support 32 of the brush 30, and the mounting plate 40 of the assembly 14.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing system comprising:
a bearing including an inner ring and an outer ring, at least one of the inner and outer rings being configured to rotate relative to the other one of the inner and outer rings, the outer ring having a bore and a groove formed in the bore, the groove having first and second lateral walls axially facing one another, a bottom connecting the first and second lateral walls, and an inner edge extending between the second lateral wall and an end face of the outer ring; and
a grounding brush assembly including a brush axially offset outwardly relative to the inner ring of the bearing, the brush having support and a plurality of conductive fibers disposed within the support, and a brush mounting plate secured to the support of the brush and including a mounting portion arranged inside the groove of the outer ring, the mounting portion including at least one collar bearing axially against the first lateral wall of the groove, a free end of the collar being radially offset inwardly relative to the inner edge of the groove or being flush with the inner edge, and at least one protrusion projecting from the collar outwardly toward the bottom of the groove, a free end of the protrusion being radially offset outwardly relative to the inner edge of the groove so as to ensure axial retention of the mounting plate relative to the outer ring, the collar having at least one region of reduced axial thickness relative to an axial thickness of a remainder of the collar, the remainder being located in the radial extension of the protrusion.

2. The system according to claim 1, wherein the mounting portion of the mounting plate includes at least one blind notch formed in the collar, oriented axially outwardly and delimiting the region of reduced axial thickness.

3. The system according to claim 1, wherein the protrusion of the mounting portion of the mounting plate bears radially against the bottom of the groove of the outer ring of the bearing.

4. The system according to claim 1, wherein the mounting portion of the mounting plate includes a plurality of protrusions, each one of the plurality of protrusions projecting from the collar outwardly toward the bottom of the groove and being spaced apart from each other in the circumferential direction, a free end of each protrusion being radially offset outwardly relative to the inner edge of the groove, the collar locally having a plurality of regions of reduced axial thickness relative to the axial thickness of the remainder of the collar, each one of the regions of reduced axial thickness being located in the radial extension of one of the protrusions.

5. The system according to claim 4, wherein each one of the plurality of protrusions are regularly spaced apart from each other in the circumferential direction.

6. The system according to claim 1, wherein the collar of the mounting portion of the mounting plate remains spaced from the second lateral wall of the groove of the outer ring of the bearing.

7. The system according to claim 1, wherein the collar of the mounting portion of the mounting plate is annular.

8. The system according to claim 1, wherein the mounting plate is made in one piece.

9. An electric motor comprising:
a housing;
a shaft; and
at least one bearing system according to claim 1 mounted radially between the housing and the shaft.

10. A method for assembling a bearing system according to claim 1, the method comprising the steps of:
axially displacing the grounding brush assembly relative to the bearing so as to position the collar of the mounting portion of the mounting plate axially against the first lateral wall of the groove of the outer ring of the bearing; and
locally deforming material of the collar to form the protrusion by a radial flow of material.
